(19) United States
(12) Patent Application Publication
(10) Pub. No.: US 2026/0127292 A1
(43) Pub. Date: May 7, 2026

(54) Systems and Methods for Accurate Assessment of Application Vulnerabilities

(71) Applicant: OPTUM, INC., Minnetonka, MN (US)

(72) Inventors: Ziqian Huang, Buffalo Grove, IL (US); Daniel Tabor, Baltimore, MD (US); Anne Owen Jackson, Waban, MA (US); Jinxia Yao, Zionsville, IN (US)

(21) Appl. No.: 18/939,721

(22) Filed: Nov. 7, 2024

(51) Int. Cl. G06F 21/57; G06F 18/2415

(52) U.S. Cl. CPC G06F 21/577; G06F 18/2415; G06F 2221/033

(57) ABSTRACT

Techniques for accurately assessing the vulnerability status of a collection of software applications are disclosed herein. An example computer-implemented method includes computing a metric indicative of time-to-vulnerability-remediation for each software application in the collection of software applications. The method further includes classifying each software application as one of a predefined set of classifications using at least the computed metrics indicative of time-to-vulnerability-remediation. The method also predicts at least one future classification for each software application in the collection of software applications. The method also outputs at least one data object indicative of, for each software application in the collection of software applications, the software application, the classification of the software application, and the predicted classification(s) of the software application.

### TECHNICAL FIELD

The present disclosure generally relates to techniques for assessing the vulnerability status of a collection of software applications.

### BACKGROUND

Prioritizing maintenance for software applications based on known vulnerabilities is a well-established problem. Classical approaches to prioritization rely on pre-computed metrics. Examples of such approaches include ranking the software applications according to their time-to-vulnerability-remediation or their adherence to service level objectives. Those applications that perform the worst with respect to these metrics are typically considered to be the highest priority candidates for maintenance or additional resources. However, these approaches neglect contextual information about the software applications.

### BRIEF DESCRIPTION OF THE DRAWINGS

The Figures described below depict preferred embodiments for purposes of illustration only. One skilled in the art will readily recognize from the following discussion that alternative embodiments of the systems and methods illustrated herein may be employed without departing from the principles of the disclosure described herein.

FIG. 1 depicts an example computing system in which various techniques of the present disclosure can be implemented.

FIG. 2A depicts an example classification and prediction architecture in accordance with various embodiments described herein.

FIG. 2B depicts an example classification and prediction architecture similar to that of FIG. 2A but incorporating re-classifications in accordance with various embodiments described herein.

FIG. 3 depicts an example architecture for predicting a sequence of one or more predicted classifications and the steady state of a Markov chain based on a transition (probability) matrix, in accordance with various embodiments described herein.

FIG. 4 depicts an example configuration of output data objects in accordance with various embodiments described herein.

FIG. 5 depicts a flow diagram representing an example computer-implemented method, in accordance with various embodiments described herein.

### DETAILED DESCRIPTION

Broadly, the present disclosure relates to techniques for quantifying and predicting risk associated with software vulnerabilities for a set of software applications. In some embodiments, the resultant data structure includes, for a first software application of the set of software applications, the name of the software application, an initial classification of the software application, and/or a sequence of one or more predicted classifications. A system classifies the first software application based at least in part on a metric indicative of a time-to-vulnerability-remediation of the software application. In some examples, the metric indicative of time-to-vulnerability-remediation may comprise a median time-to-vulnerability-remediation of a set of vulnerabilities associated with the first software application. In some embodiments, the system generates, as the set of classifications to associate with the first software application, a subset of classifications from a predetermined set of classifications based at least in part on a particular context in which the present techniques are deployed. For example, the system may generate the predetermined set of classifications specifically for developing an automated prioritization scheme or to provide a comprehensive overview of the vulnerability status of the set of software applications to a human reviewer. In some examples, the automated prioritization scheme may be used to determine a timeline for decommissioning a software application, decommission or otherwise prevent or pause execution a software application if a classification or time-to-vulnerability-remediation satisfies a criteria, transmit a software application or portion thereof to a computing device associated with vulnerability remediation, and/or the like. Alternatively and/or additionally, the automated prioritization scheme may rank a set of software applications according to need for additional maintenance and assign resources accordingly. The system may additionally or alternatively predict a sequence of (one or more) future classifications for a first software application. The sequence of classifications predicted for a given software application generally indicates how the metrics associated with the time-to-vulnerability-remediation of the software application are predicted to change over time and may be associated with respective likelihoods (i.e., posterior probabilities) of future occurrence.

In some instances, metrics indicative of a software application's time-to-vulnerability remediation may be misleading with respect to application prioritization when an organization considers those metrics in isolation. For example, a newly deployed, mission-critical software application may have many vulnerabilities but, because the application is newly deployed, the application may have an undefined or very low mean-time-to-vulnerability-remediation. Hence, schemes that prioritize applications based on such a metric alone would deprioritize the mission-critical application. By predicting how the application's vulnerabilities will evolve (i.e., predicting a sequence of one or more future categories), the disclosed techniques can more accurately prioritize those mission-critical applications with metrics that are likely to worsen. Conversely, an application may have a high mean-time-to-vulnerability-remediation, but an organization may have already deployed significant resources to reducing the application's mean-time-to-vulnerability-remediation or the application may be scheduled for imminent decommissioning. Thus, a classical prioritization scheme might suggest that the application requires additional resources. By predicting a sequence of one or more future categories (e.g., that the mean-time-to-vulnerability-remediation of the relevant application is likely to significantly decrease), the disclosed techniques can more accurately (de) prioritize the application. By incorporating predictions into prioritization schemes, organizations can then deploy maintenance resources with increasing efficiency.

The disclosed system classifies a first software application into one of a predetermined set of classifications, based on, at least in part, a metric indicative of the time-to-vulnerability-remediation of the software application. The use of a predetermined set of classifications provides a further technical advantage in that it helps to avoid, or reduce the number of, “false negatives” where an application in need of resources is not indicated as such. In some embodiments, for example, one classification indicates that a software application is mission-critical but has insufficient data to compute a meaningful metric indicative of time-to-vulnerability-remediation. The organization could then prioritize software applications that fall into such a category, thereby ensuring that mission-critical systems are always (or at least, more frequently) appropriately prioritized.

In some embodiments, the metric indicative of time-to-vulnerability remediation is a Kaplan-Meier median metric. The Kaplan-Meier median is advantageous over the classical definition of median because it accounts for vulnerabilities which remain open at the time of computation. If one uses the classical median, one must either omit those vulnerabilities that have not yet been resolved or estimate a time-to-vulnerability-remediation for each of them. Either of these two approaches can result in a wildly inaccurate representation of the current situation.

Of course, it should be appreciated that the advantages and technical improvements described above and elsewhere herein are not the only advantages and/or technical improvements that may be realized as a result of the techniques described herein. Other advantages and/or technical improvements to the functioning of a computer itself or other technologies or technical fields may be apparent to one of ordinary skill in the art. For example, the techniques described herein may improve the security posture of one or more computing devices and/or software component(s) thereof by ensuring resources allocated to remediation of vulnerabilities are most impactful and targeted to the more accurately detected vulnerability priorities. Moreover, the techniques described herein may be readily applied in any suitable field for any suitable purpose.

### Example Computing System

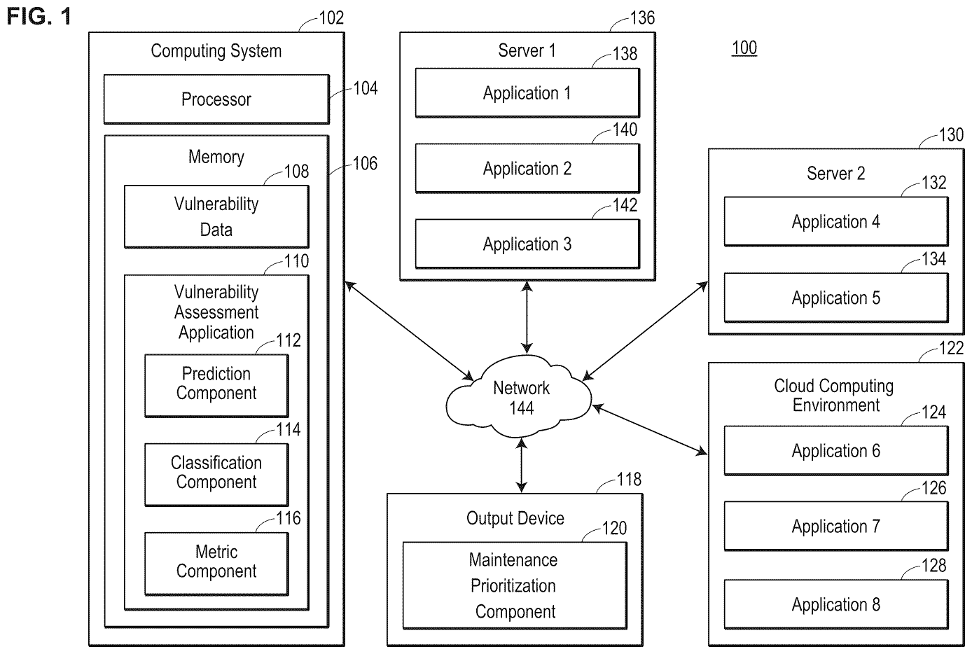

FIG. 1 depicts an example system 100 in which various techniques of the present disclosure can be implemented.

The example system 100 in FIG. 1 includes a computing system 102, an output device 118, a cloud computing environment 122, and two servers 136, 130, some or all of which are communicatively coupled via a network 144. Generally, in some embodiments, one entity is associated with (e.g., owns, rents, maintains, etc.) all devices in the example system 100. Broadly, the entity typically configures the computing system 102 to assess the vulnerability status of software applications on various servers. In the depicted example of FIG. 1, the entity has deployed several applications 138, 140, 142, 132, 134, 124, 126, 128 on several different computing environments including servers 136, 130 and a cloud computing environment 122. In some embodiments, different subgroups of the entity manage the different computing environments. For example, in some embodiments, the servers 136, 130 host the customer service applications of the entity, while the cloud computing environment 122 hosts the logistics applications of the entity. In some embodiments, however, the entity does not distribute applications across the servers 136, 130 and the cloud computing environment 122 according to application type, and instead distributes the applications across the servers 136, 130 and cloud computing environment 122 according to hardware available at the servers 136, 130 and in the cloud computing environment 122, and/or based on other factors.

The computing system 102 is generally configured to monitor the software vulnerabilities associated with the applications 138, 140, 142, 132, 134, 124, 126, 128 running on the servers 136, 130 and cloud computing environment 122. Furthermore, the computing system 102 computes statistics regarding the aforementioned software vulnerabilities and classifies the software applications 138, 140, 142, 132, 134, 124, 126, 128 into different classifications using these statistics. In addition, the computing system 102 predicts how the software applications 138, 140, 142, 132, 134, 124, 126, 128 will change classifications over time. In the example of FIG. 1, the system 100 also includes an output device 118. In some embodiments, the output device 118 uses the statistics, information, and predictions computed by the computing system 102 as inputs for a maintenance prioritization component 120. The maintenance prioritization component 120 prioritizes the applications 138, 140, 142, 132, 134, 124, 126, 128 according to their need for maintenance resources. In other embodiments, the output device 118 is a personal device, such as a phone or tablet, and the output device 118 displays a summary of the applications 138, 140, 142, 132, 134, 124, 126, 128, the vulnerabilities of the applications, the classifications of a first software application, and the predicted classification of the first software application to the user.

In other embodiments, a first entity owns the computing system 102 while a second entity owns the servers 136, 130, owns the output device 118, and has deployed applications 124, 126, 128 on the cloud computing environment 122. In such an embodiment, the first entity may be providing the summary as a service to the second entity, for example.

While FIG. 1 depicts four distinct devices/systems 102, 118, 130, 136 and a cloud computing environment 122, the number of devices and environments present in the system 100 can vary. In some embodiments, for example, the system 100 includes only one device, which serves as the computing system 102, servers 136, 130, and output device 118, while no applications are deployed on the cloud computing environment 122. In other embodiments, the computing system 102 and output device 118 are distinct, but there are also thousands of applications running on thousands of different servers and computing environments.

The computing system 102 includes both a processor 104 and memory 106. The memory 106 stores application vulnerability data 108 and instructions of a vulnerability assessment application 110. The vulnerability assessment application 110 includes a prediction component 112, a classification component 114, and a metric component 116. In the example of FIG. 1, the first server 136 is configured to store and execute instructions of three applications 138, 140, 142 while the second server 130 is configured to store and execute instructions of two applications 132, 134. The cloud computing environment 122 is configured to store and execute instructions of three additional applications 124, 126, 128. The system 100 also includes an output device 118 that is configured to store and execute instructions of a maintenance prioritization component 120. In some embodiments, the output device 118 uses the data objects for other purposes, such as generating and displaying a human-readable report and/or archiving the data objects in a database. In some embodiments, the output device 118 is omitted and the maintenance prioritization component 120 is stored in memory 106 of the computing system 102.

In the example shown in FIG. 1, the computing system 102 receives and stores application vulnerability data 108 from the first server 136, the second server 130, and the cloud computing environment 122 via the network 144, with the vulnerability data 108 being indicative of the vulnerability status of those applications running on the respective servers and computing environments. In some embodiments, the computing system 102 requests and/or pulls the information from the first server 136, second server 130, and cloud computing environment 122 via the network 144. However, in some embodiments, the first server 136, second server 130, and cloud computing environment 122 periodically push information to the computing system 102 via the network 144. In some embodiments, information technology and cybersecurity professionals gather the application vulnerability data 108 and send it to the computing system 102 via the network 144.

The computing system 102 is generally configured to execute the vulnerability assessment application 110, and the vulnerability assessment application 110 is generally configured to execute the metric component 116 and provide application vulnerability data 108 as an input to the metric component 116. In some examples, the metric component 116 is generally configured to compute metrics related to outstanding vulnerabilities, their impact, how frequently vulnerabilities are being remediated, and/or the like for a first software application of the set of software applications. For example, the metric component 116 may compute a metric indicative of a time-to-vulnerability-remediation of the first application, such as by determining, based at least in part on a set of vulnerabilities indicated as being associated with the first application, a total, average, median length of time from notification of existence of a vulnerability in the first software application to a time the vulnerability was remediated or a current date if the vulnerability has not been remediated. Furthermore, in some embodiments, a median time-to-vulnerability-remediation may be determined as a Kaplan-Meier median. In some embodiments, the metric component 116 may additionally or alternatively compute a metric indicative of adherence to service level agreement(s) (SLA(s)) associated with an application, such as a number or average number of days past a SLA-defined period for remediating vulnerabilities for vulnerabilities associated with the application or a number of vulnerabilities that have not been remediated by the SLA-defined period. Additionally or alternatively, the metric component 116 may compute statistics regarding the vulnerabilities of an application such as an age of the oldest open vulnerability of the application, a metric indicative of the severity of the vulnerabilities associated with the application (e.g., average or median common vulnerabilities and exploits (CVE) score), and/or a metric indicative of the fraction of vulnerabilities of the application that have been resolved.

The vulnerability assessment application 110 is also generally configured to execute the classification component 114. The classification component 114 is generally configured to classify an application represented in the application vulnerability data 108 into one of a predefined set of categories based on at least one metric indicative of the time-to-vulnerability-remediation of the application. In some embodiments, the classification component 114 classifies a software application represented in the application vulnerability data 108 into one of the predefined set of categories using both a metric indicative of time-to-vulnerability-remediation and auxiliary metrics. In some embodiments, the predetermined set of classifications is pre-determined to reflect both a metric indicative of the median time-to-vulnerability-remediation of an application and the relative age of the vulnerabilities of the application.

For example, in some embodiments, there may be five predetermined classifications, and the metric component 116 attempts to compute a Kaplan-Meier median time-to-vulnerability-remediation for an application based on the number of vulnerabilities that are detected or notifications of which are received (e.g., from a common vulnerabilities and exploits (CVE) authority) within a predetermined enrollment window (e.g., a period of time taken to be representative of the current status of vulnerabilities associated with the application). The classification component 114 subsequently uses the result produced by the metric component 116 to assign a classification to the application. In some of these embodiments, the first classification is indicative of those applications for which the Kaplan-Meier median can be computed; the second classification is indicative of those applications for which a Kaplan-Meier median cannot be computed, but new vulnerabilities of the application were detected/received within the enrollment window; the third classification is indicative of those applications for which a Kaplan-Meier median cannot be computed and no new vulnerabilities were detected/received within the enrollment window, but vulnerabilities were detected/received after the enrollment window closed; the fourth classification is indicative of those applications for which a Kaplan-Meier median cannot be computed and the system detected/received vulnerabilities neither within nor after the enrollment window closed, but vulnerabilities were introduced prior to the beginning of the enrollment window; and the fifth classification is indicative of those applications for which a Kaplan-Meier median cannot be computed and no vulnerabilities were detected/received before the enrollment window opened, within the enrollment window, or after the enrollment window closed.

The vulnerability assessment application 110 is also generally configured to execute the prediction component 112. The prediction component 112 is generally configured to generate a sequence of classifications, wherein each classification/element of the sequence is one of the predetermined classifications, for each application represented in the application vulnerability data 108. In some embodiments, the elements of the sequence correspond to equally spaced future dates (e.g., each separated by one month, or by six months, etc.) or spaced by some other function (e.g., linearly, logarithmically, or exponentially increasing time periods between dates). For other embodiments, the elements correspond to arbitrary or user-defined future dates. In some embodiments, the prediction component 112 may determine a Markov chain that indicates this sequence and a set of probabilities associated therewith. In some examples, the Markov chain may be defined using a transition (probability) matrix constructed from observed rates of transition between classifications. Additionally or alternatively, in some of these embodiments, the prediction component 112 may determine a set of probabilities associated with the sequence, wherein a first probability indicates a likelihood (i.e., a posterior probability) that a software application will transition from a previous classification associated with a last date of the sequence to a particular classification on a next date of the sequence. Additionally or alternatively, the prediction component 112 may determine a probability that the application will be classified as a particular classification within a given time period. The prediction component 112 uses these transition probabilities to generate a transition (probability) matrix and then defines a Markov chain using this transition (probability) matrix. In some embodiments, if the Markov chain has a steady state, the prediction component 112 may additionally or alternatively compute the steady state (e.g., the stationary distribution) of the Markov chain (i.e., the long-term probability of the application being classified in each of the classifications).

In some embodiments, if the steady state computation indicates a high probability that a software application will be in a particular classification (e.g., greater than a predefined threshold probability), then the system automatically schedules the application for decommission. Alternatively or additionally, the system may periodically update the transition (probability) matrix and track changes in the steady state probabilities. In some embodiments, for example, the system tracks a moving average of the steady state probability associated with the particular classification, and if the moving average surpasses a predefined threshold, then the system schedules the application for decommission. In other embodiments, the system allocates employee maintenance time to be applied to the application.

For a first software application represented in the application vulnerability data 108, the computing system 102 sends a set of data objects indicative of (1) the software application, (2) the classification of the software application, and/or (3) the sequence of predicted classifications of the software application to the output device 118 via the network 144. Generally, the data objects can comprise any form(s) suitable for representing and conveying data, and the data objects can comprise structured and/or unstructured data. Possible formats of the data objects include text files, JSON objects, and datagrams, for example. In some embodiments, the computing system 102 sends a single data object. In some embodiments, for a first software application represented in the application vulnerability data 108, the computing system 102 sends a set of data objects that are collectively indicative of a metric indicative of the time-to-vulnerability-remediation of the software application, and in some embodiments the computing system 102 sends a set of data objects that are collectively indicative of any additional metrics computed by the metric component 116. The output device 118 is generally configured to execute the maintenance prioritization component 120 with the set of data objects as input. In some embodiments, the maintenance prioritization component 120 uses this data to rank the applications according to their need for additional maintenance. However, in other embodiments, the maintenance prioritization component 120 outputs a report indicative of the current status of the software applications or archives the data for future use. In some of these embodiments, the output device 118 displays the output report to a user. In other embodiments, the output device 118 displays the data objects to a user.

Generally, the computing system 102 is or includes any device that is associated with (e.g., owned and/or operated by) a particular entity and that is capable of receiving application vulnerability data 108 from the first server 136, second server 130, or cloud computing environment 122 via the network 144. In some embodiments, the computing system 102 is a server or a collection of servers hosting the vulnerability data 108. In the embodiment in FIG. 1, the server includes both a processor 104 and memory 106. The memory 106 includes both the vulnerability data 108 and the instructions constituting the vulnerability assessment application 110. The processor 104 can include any suitable number of processors and/or processor types, including one or more central processing units (CPUs), graphics processing units (GPUs), and so on. In some embodiments, the processor 104 also includes processing hardware such as one or more field-programmable gate arrays (FPGAs), application specific integrated circuits (ASICs), and so on. The memory 106 includes one or more memories (e.g., volatile memory, non-volatile memory, solid-state memory, hard drives, external memory, etc.), registers, and/or other components that store information, executable software, and/or the like. The memory 106 may comprise one or more memories and is an example of a non-transitory computer-readable medium.

The first server 136 and the second server 130 may include any hardware suitable to run their respective software applications. Each of the servers 130, 136 may be a single server, or a collection of any suitable number of servers and/or other computing devices. In the embodiment in FIG. 1, the first server 136 and second server 130 are communicatively connected to the computing system 102 via the network 144, and the first server 136 and second server 130 transmit application vulnerability data 108 to the computing system 102 via the network 144. In other embodiments, human professionals gather the vulnerability data 108 directly from the first server 136 and second server 130 and subsequently physically transport the data via an external memory device to the computing system 102.

The cloud computing environment 122 includes hardware that is sufficient to execute applications 124, 126, 128. The cloud computing environment 122 includes any suitable number (e.g., hundreds or thousands) of nodes (e.g., servers or processors). In other embodiments, the cloud computing environment 122 is a single node (e.g., single server or processor).

In the embodiment in FIG. 1, the network 144 is a physical network directly connecting all component devices of the system 100. However, in other embodiments, the network 144 includes several sub-networks of various types (e.g., one or more wired and/or PANs or LANs, and/or one or more WANs such as the Internet). In some embodiments, the network 144 includes one sub-network for communication between the computing system 102 and each other component in the system 100 (e.g., 118, 122, 130, and 136). In some embodiments, the components of system 100 communicate over the network 144 via connected networking protocols such as Transmission Control Protocol (TCP) or Stream Control Transmission Protocol (SCTP). However, in some embodiments, the components of the system 100 communicate via connectionless networking protocols such as User Datagram Protocol (UDP). It will be understood that the above disclosure is one example and does not necessarily describe every possible embodiment. As such, it will be further understood that alternate embodiments may include fewer, alternate, and/or additional components and/or operations.

### Example Execution Architectures

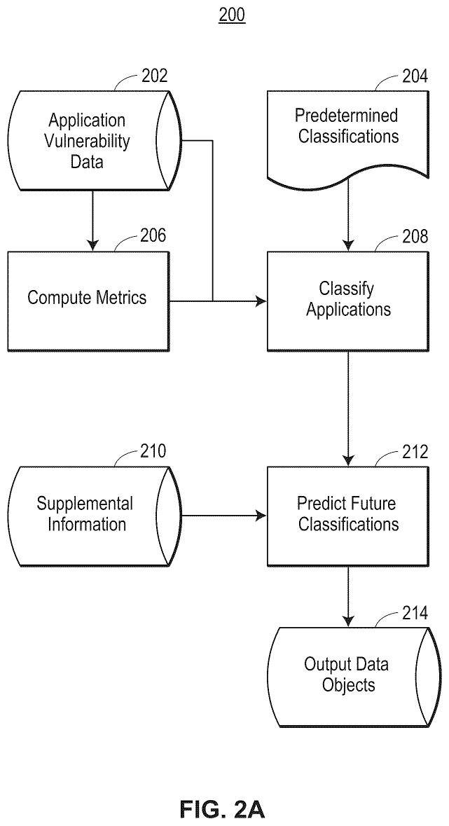

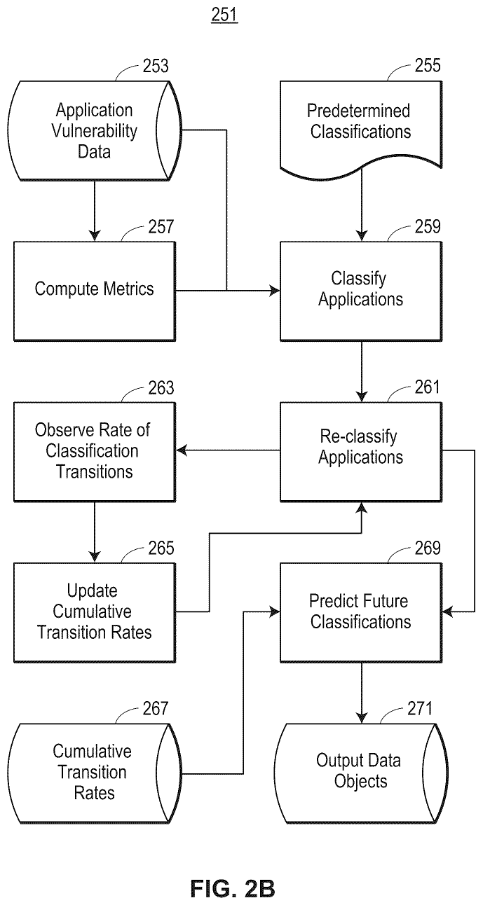

FIG. 2A depicts an example classification and prediction sequence 200, in accordance with various embodiments described herein. The example classification and prediction sequence 200 is typically performed by a computing device, such as the computing system 102 in the system 100 in FIG. 1. The example classification and prediction sequence 200 illustrated in FIG. 2A is for the purposes of discussion only, and additional steps and/or data may also be incorporated or substituted into the example sequence. While FIG. 2A is described herein with reference to the elements of FIG. 1, the example classification and prediction sequence 200 can be implemented on a wide variety of systems, and describing the classification and prediction sequence 200 in terms of the system 100 in FIG. 1 does not limit deployment of the sequence 200 to the system 100 of FIG. 1.

Initially, the computing system 102 transmits application vulnerability data 202 (e.g., application vulnerability data 108) to metric component 116, which computes metrics associated with the application vulnerability data 202 (block 206). Upon computing these metrics, the computing system 102 transmits these metrics; the application vulnerability data 202; and the predetermined classifications 204 to the classification component 114 (block 208). This classification component 114 assigns a classification from the predetermined classifications 204 to a first application represented in the application vulnerability data 202. The computing system 102 then transmits these classifications to the prediction component 112. In addition, the computing system 102 sends supplemental information 210 to the prediction component 112 (block 212). In some embodiments, the supplemental information 210 is indicative of the historical rate at which applications within one classification have transitioned to another classification for each ordered pair of classifications. Furthermore, in some embodiments, the supplemental information 210 is indicative of previous classifications of those applications represented in the application vulnerability data 202.

For a first application represented in the application vulnerability data 202, the prediction component 112 computes a sequence of one or more predicted classifications of the application based on the current classification of the application and the supplemental information 210 (block 212). In some embodiments, the prediction component 112 generates the sequence of predicted classifications by using the supplemental information 210 to define a Markov chain. In other embodiments, the prediction component 112 uses at least one machine learning model to generate the sequence of classifications. After the prediction component 112 computes the sequence of classifications, the computing system 102 outputs the current classifications of those software applications represented in the application vulnerability data 202 and the predicted future classifications corresponding to those software applications represented in the application vulnerability data 202 in a set of output data objects 214. In some embodiments, for a first application represented in the application vulnerability data 108, the computing system 102 also includes metrics indicative of the time-to-vulnerability-remediation of the application in the output data objects. Furthermore, in some embodiments, the computing system 102 includes other metrics in the output data objects 214. For some of these embodiments, the metrics included in the output data objects 214 comprise, for a first application represented in the application vulnerability data 202, a metric indicative of the median time-to-vulnerability-remediation of the application, a metric indicative of the oldest open application vulnerability, and a metric indicative of the adherence to service level agreements of the application. In some of these embodiments, the metric indicative of the adherence to service level agreements is the fraction of time, over the past year (or other predetermined time period), that the application has been in compliance with one or more applicable service level agreements.

FIG. 2B depicts an iterative version of the embodiment depicted in FIG. 2A. As in the classification and prediction sequence 200 in FIG. 2A, the classification and prediction sequence 251 in FIG. 2B can be performed by a system such as the system 100 in FIG. 1. In other embodiments, additional steps and/or data may be incorporated or substituted into the example sequence 251. While FIG. 2B is described herein with reference to the elements of FIG. 1, the example classification and prediction sequence 251 can be implemented on a wide variety of systems, and describing the classification and prediction sequence 251 in terms of the system 100 does not limit deployment of the sequence 251 to the system 100.

Initially, the system executing the sequence in FIG. 2B transmits application vulnerability data 253 (e.g., 108) to the metric component 116 (block 257). As in the case of FIG. 2A, for a first application represented in the application vulnerability data 253, the metric component 116 computes a metric indicative of the time-to-vulnerability-remediation of the application (block 257). In some embodiments, the metric component 116 also computes additional metrics. The computing system 102 then transmits the application vulnerability data 253, the computed metrics indicative of the time-to-vulnerability remediation of the application, and the predetermined classifications 255 to the classification component 114 (block 259).

For a first application represented in the application vulnerability data 253, the classification component 114 computes a classification corresponding to the application (block 259). Upon classifying the software applications, the computing system 102 then waits for a predetermined amount of time. When this period of time expires, the classification component 114 re-classifies a first software application represented in the application vulnerability data 253 into one of the predetermined classifications 255. The computing system 102 observes the rate at which applications transition from any one of the predetermined classifications to any other predetermined classification (block 263). The computing system 102 records these observed rates and updates a set of cumulative transition rates 267 (block 265). The computing system 102 then re-classifies the software applications again (block 261), and iterates over the subsequence of blocks 263, 265, and 261 a predetermined number of times before proceeding to block 269. However, in some embodiments, the computing system 102 iterates over the subsequence of blocks 263, 265, and 261 until an external flag directs the computing system 102 to proceed to block 269. In some of these embodiments, a user activates the external flag. In some embodiments, the computing system 102 proceeds from block 259 to block 261 to block 263 to block 265 and then directly to 269 rather than repeating block 261. In some embodiments, prior to the classification component 114 re-classifying a first software application, the metric component 116 first computes an updated metric indicative of the time-to-vulnerability remediation for a first application represented in the application vulnerability data 253 on each iteration of the sequence 251. In some of these embodiments, the classification component re-classifies a first software application represented in the application vulnerability data 253 based on a most recent updated metric indicative of the updated time-to-vulnerability-remediation of the application.

When the classification component 114 finishes re-classifying the applications for the last time, the system 100 transmits the current classifications of the applications to the prediction component 112 (block 269). In addition, the system 100 also transmits the cumulative transition rates 267 to the prediction component 112 (block 269). Analogously to the case in FIG. 2A, the prediction component 112 uses both the classifications of the software applications and the cumulative transition rates 267 to generate a sequence of classifications for a first application represented in the application vulnerability data 253. In some embodiments, the prediction component 112 uses the cumulative transition rates 267 to define a Markov chain and uses the Markov chain to generate the sequences of classifications (block 269). In other embodiments, the prediction component 112 uses a machine learning model to generate the sequences of classifications (block 269).

Upon termination of the prediction component 112, the executing system outputs the current classifications of those software applications represented in the application vulnerability data 253 and the predicted future classifications corresponding to those software applications represented in the application vulnerability data 253 in a set of output data objects 271. Within some embodiments, there is one output data object in the set of output data objects 271. In some embodiments, the executing system also includes metrics computed by the metric component 116 in the output data objects 271.

### Example Prediction Component

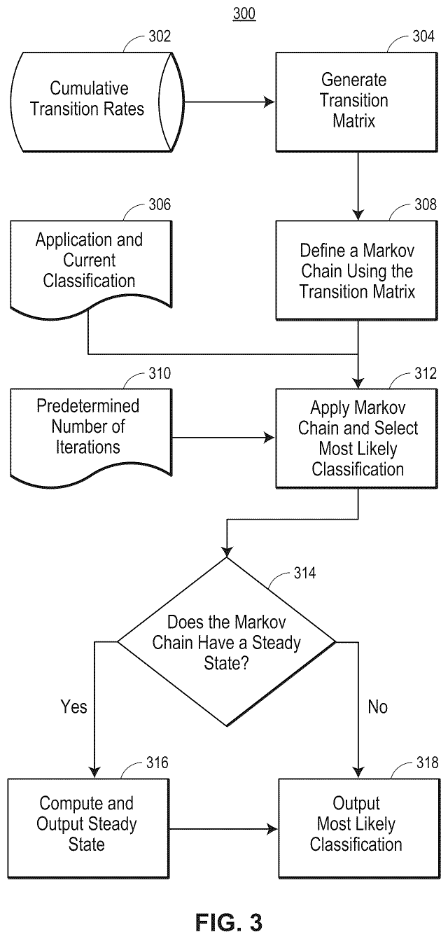

FIG. 3 depicts an execution sequence 300 that can be implemented by a prediction component (e.g., prediction component 112) within the sequence 251 of FIG. 2B to generate a sequence of predicted classifications for an application (block 269). Upon receiving the cumulative transition rates 302, the prediction component represents these transition rates as a transition (probability) matrix (block 304). The prediction component then uses this transition (probability) matrix to define a Markov chain (block 308). In some embodiments, to generate the first element of the sequence, the prediction component multiplies the transition (probability) matrix by a vector indicative of the current classification 306 of the application (block 312). The prediction component then selects a most likely future classification based on the result of the multiplication (block 312). Subsequently, the prediction component generates a vector indicative of this most likely future classification, and again multiplies the vector indicative of the most likely future classification by the transition (probability) matrix (block 312). The prediction component iterates this procedure of generating a vector indicative of a most likely future classification, multiplying the vector by the transition (probability) matrix, and using the result of the multiplication to select an additional most likely future classification for a predetermined number of iterations 310 (block 312). In other embodiments, the number of iterations is chosen probabilistically. Each chosen most likely future classification is an element of the sequence of predicted classifications.

After computing the sequence of predicted classifications, the prediction component assesses whether the Markov chain has a steady state (block 314). If the Markov chain does have a steady state, then the prediction component computes the steady state and subsequently outputs both the steady state and the sequence of classifications (blocks 316, 318). If the Markov chain does not have a steady state, then the prediction component outputs the sequence of classifications (block 318).

### Example Data Objects

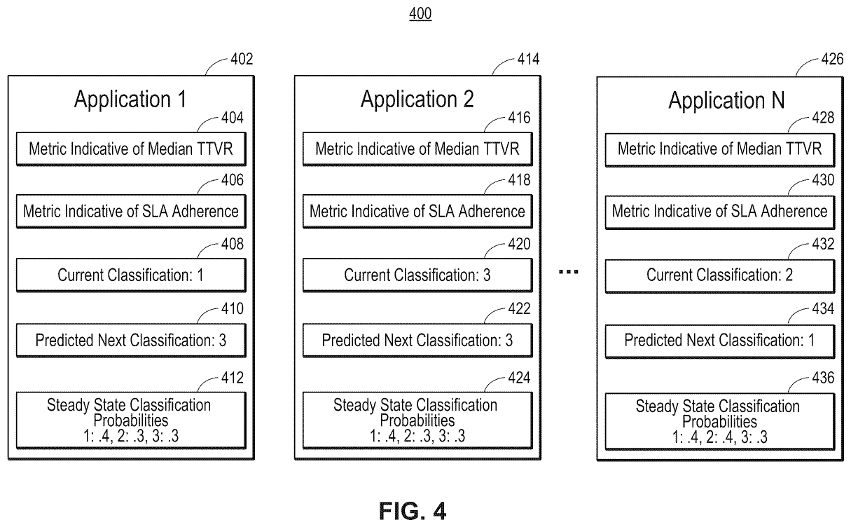

FIG. 4 depicts data objects 400 that could be output by an embodiment of the present disclosure. For example, the data objects 400 could be generated by the computing system 102 in FIG. 1. After the computing system 102 in FIG. 1 generates the data objects 400, the computing system 102 sends them to the output device 118 via the network 144. In some embodiments, the output device 118 displays the data objects 400 on a screen. In some embodiments, the output device 118 processes the data objects 400 into a human readable report and displays the human readable report on a screen. In some embodiments, the output device archives the data objects 400 in a database.

FIG. 4 depicts three data objects 402, 414, 426, each corresponding to a respective application. These data objects are representative of a wider collection of N data objects 400 generated by an embodiment of the present disclosure. In some embodiments, each data object 402, 414, 426 consists of multiple pieces of information. The data object 402 corresponding to Application 1, for example, contains two metrics. One metric 404 is indicative of the median time-to-vulnerability-remediation of Application 1, while the other metric 406 is indicative of the adherence to the service level agreements (SLA) of Application 1. The data objects 414, 426 corresponding to Application 2 and Application N contain similar pieces of information 416, 418, 428, 430. In the system 100 depicted in FIG. 1, the metric component 116 computes these metrics/pieces of information 404, 406, 416, 418, 428, 430.

Furthermore, the data object 402 corresponding to Application 1 also contains the current classification 408 to which Application 1 is assigned. The data objects 414 and 426 corresponding to Application 2 and Application N also contain classifications 420, 432. In the system 100 in FIG. 1, the classification component 114 assigns these classifications 408, 420, 432. Hence, in the present embodiment, Application 1 corresponds to classification 1, Application 2 corresponds to classification 3, and Application N corresponds to classification 2.

The data object 402 corresponding to Application 1 also contains a predicted next classification 410. In addition, the data objects 414, 426 corresponding to Application 2 and Application N contain similar predictions. In the system 100 in FIG. 1, the prediction component 112 makes these predictions. In some embodiments, the predicted next classifications 410, 422, 434 represent the most likely next classification of the corresponding application. As is the case in the data object 414 corresponding to Application 2, in some embodiments, the predicted next classification is the same as the current classification.

In some embodiments, the output data objects 400 contain sequences of predicted classifications that are of length greater than one. In the embodiment of FIG. 4, the output data objects 402, 414, and 426 each contain only one predicted classification 410, 422, and 434, respectively.

In some embodiments, a single data object is indicative of, for a first software application in the set of software applications, the software application, a respective initial classification of the software application, and a respective sequence of predicted classifications of the software application. In some embodiments, each data object is indicative of a software application, a current classification of the software application, a classification in a predicted sequence of classifications, a position in the predicted sequence of classifications, or some combination thereof. Furthermore, in some embodiments, one data object is indicative of a subset of the types of information of which another data object is indicative. For example, in some embodiments, one data object is indicative of a software application and a classification of the software application, while another data object is only indicative of a software application. Other arrangements are also possible.

Finally, the data object 402 corresponding to Application 1 contains information indicative of the steady state classification probabilities 412 of the application. In some embodiments, these probabilities represent the long-term probability that the application will be classified into any given classification. In the case of Application 1, these probabilities imply that at or after a particular time and/or date in the future, there is a 40% chance that Application 1 would be classified into classification 1, a 30% chance that Application 1 would be classified into to classification 2, and a 30% chance that Application 1 would be classified into classification 3. This allows the predictions to indicate the long-term predicted classification status of the application in the future. In the system 100 depicted in FIG. 1, the prediction component 112 computes this value.

The data objects 414 and 426 corresponding to Application 2 and Application N also contain information indicative of steady state classification probabilities 424, 436. In this example, these steady state classification probabilities 424, 436 are identical to each other, and these probabilities are further identical to the steady state probabilities 412 in the data object 402 corresponding to Application 1. Embodiments that make predictions using the same Markov chain for all applications will have this property. In other embodiments, such as those that use a different Markov chain for each application, the steady state classification probabilities will likely be distinct.

### Example Computer-Implemented Methods

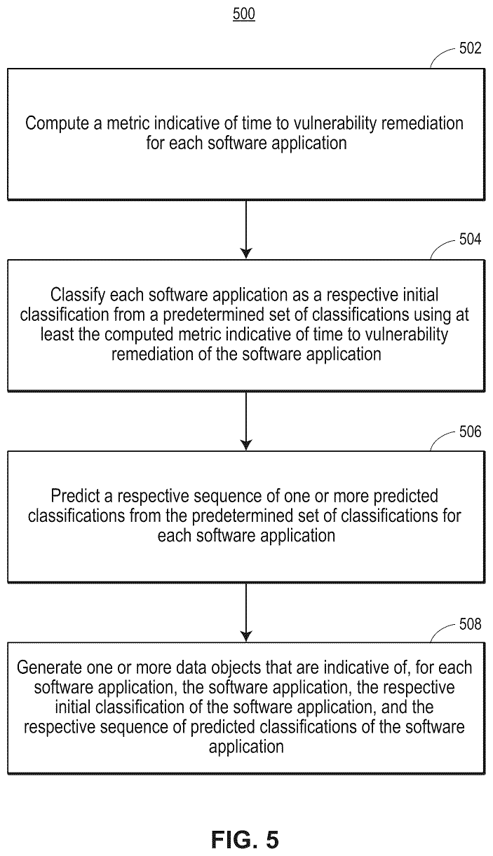

FIG. 5 depicts a flow diagram representing an example computer-implemented method 500, in accordance with the various embodiments described herein. The method 500 may be implemented by one or more processors of the example system 100, such as the processor 104 of the computing system 102.

The method 500 includes computing a metric indicative of time-to-vulnerability-remediation for a first software application in a set of software applications (block 502). The method 500 further includes classifying a first software application in the set of software applications as a respect initial classification from a predetermined set of classifications. To classify the applications, the method 500 uses at least the computed metric indicative of time-to-vulnerability-remediation of the software application (block 504). In some embodiments of the method 500, the metric indicative of time-to-vulnerability-remediation comprises a median time to vulnerability remediation. In some of these embodiments, computing the median time-to-vulnerability-remediation comprises using a survival analysis technique. Furthermore, in some of these embodiments, the survival analysis technique comprises a Kaplan-Meier estimator. In other embodiments, the survival analysis technique comprises a Cox proportional hazards model.

The method 500 further includes predicting, for a first software application in the set of software applications, a respective sequence of one or more predicted classifications from the predetermined set of classifications (block 506). In some embodiments, a first element of the respective sequence of predicted classifications corresponds to a different date and time. Furthermore, the method 500 includes generating one or more data objects that are collectively indicative of, for a first software applications in the set of software applications, the software application, the respective initial classification of the software application, and the respective sequence of predicted classifications of the software application (block 508).

In some embodiments of the method 500, the method further comprises computing an updated metric indicative of time-to-vulnerability-remediation for a first software application in the set of software applications. Furthermore, in these embodiments, the method further comprises re-classifying, for a first software application in the set of software applications, the software application into an updated respective classification from the predetermined set of classifications using at least the updated metric indicative of time-to-vulnerability-remediation of the software application. Furthermore, in these embodiments, the method further comprises predicting, for a first software application in the set of software applications, an updated respective sequence of one or more predicted classifications from the predetermined set of classifications. In addition, in these embodiments, the method further comprises generating one or more updated data objects that are collectively indicative of, for a first software application in the set of software applications, the software application, the updated respective classification of the software application, and the updated respective sequence of predicted classifications of the software application. Furthermore, in some of these embodiments, predicting the updated respective sequence of predicted classifications comprises observing frequencies at which software applications transition from one classification before re-classification to a second classification after re-classification, generating a transition (probability) matrix based on the observed frequencies, defining a Markov chain based on the transition (probability) matrix, and generating the updated respective sequence of predicted classifications based on the Markov chain. In some of these embodiments, when the Markov chain has a steady state, the updated data objects are collectively indicative of the steady state.

Of course, it is to be appreciated that the actions of the method 500 may be performed any suitable number of times, and that the actions described in reference to the method 500 may be performed in any suitable order.

### EXAMPLES

Example 1. A method comprising: computing, by one or more processors, a metric indicative of time-to-vulnerability-remediation for a first software application; classifying, by the one or more processors, vulnerability remediation associated with the first software application as a respective initial classification from a predetermined set of classifications using at least the metric; predicting, by the one or more processors, a first sequence comprising one or more predicted classifications, from the predetermined set of classifications, that the first software application is predicted to be classified as at a set of discrete future times; and generating, by the one or more processors, a data object that identifies the first software application and indicates at least one of the respective initial classification or the first sequence.

Example 2. The method of Example 1, further comprising: computing, by the one or more processors, an updated metric indicative of time-to-vulnerability-remediation for the first software application; re-classifying, by the one or more processors, vulnerability remediation associated with the first software application as an updated respective classification from the predetermined set of classifications using at least the updated metric; predicting, by the one or more processors, an updated first sequence comprising one or more predicted classifications, from the predetermined set of classifications, that the first software application is predicted to be classified as at a set of discrete future times; and generating, by the one or more processors, an updated data object that identifies the first software application and indicates at least one of the updated respective classification or the updated first sequence.

Example 3. The method of Example 1 wherein the first software application is an element of a set of software applications.

Example 4. The method of Example 1, wherein predicting the first sequence comprises: determining frequencies at which one or more software applications have transitioned from one classification before re-classification to a second classification after re-classification during a time window; generating a transition (probability) matrix based on the determined frequencies; determining a Markov chain based on the transition (probability) matrix; and generating the first sequence based on the Markov chain.

Example 5. The method of Example 1, wherein the first sequence further comprises one or more matrices that are computed using a Markov chain and are indicative of one or more probabilities that the first software application will be classified as one or more classifications from the predetermined set of classifications at a discrete set of times.

Example 6. The method of Example 5, further comprising: determining to schedule the first software application for uninstallation or decommissioning based at least in part on at least one of: determining the Markov chain has a steady state, determining a frequency with which one or more classifications from the predetermined set of classifications appear in the first sequence, or determining that a first probability of a set of probabilities associated with the steady state meets or exceeds a threshold.

Example 7. The method of Example 1, wherein computing the metric comprises determining a median time-to-vulnerability-remediation.

Example 8. The method of Example 7, wherein computing the median time-to-vulnerability-remediation comprises using a survival analysis technique, the survival analysis technique comprising at least one of a Kaplan-Meier estimator or a proportional hazards model.

Example 9. The method of Example 8, wherein the survival analysis technique is the Kaplan-Meier estimator and the predetermined set of classifications comprises at least one of: a first classification that is indicative of applications where a Kaplan-Meier median can be computed for a set of durations of vulnerabilities associated with the application and detected or received within an enrollment window; a second classification that is indicative of applications where a Kaplan-Meier median cannot be computed for the set of durations and vulnerabilities were detected or received within the enrollment window; a third classification that is indicative of applications where a Kaplan-Meier median cannot be computed for the set of durations, no vulnerabilities were detected or received within the enrollment window, and vulnerabilities were detected or received after the enrollment window closed; a fourth classification that is indicative of applications where a Kaplan-Meier median cannot be computed for the set of durations, no new vulnerabilities were detected or received within the enrollment window, no vulnerabilities were detected or received after the enrollment window closed, and vulnerabilities were detected or received prior to the enrollment window opening; or a fifth classification that is indicative of applications where a Kaplan-Meier median cannot be computed for the set of durations, no vulnerabilities were detected or received prior to the enrollment window opening, no vulnerabilities were detected or received within the enrollment window, and no vulnerabilities were detected or received after the enrollment window closed.

Example 10. A system comprising: one or more processors; and one or more memories storing processor-executable instructions that, when executed by the one or more processors, cause the one or more processors to perform operations comprising: computing a metric indicative of time-to-vulnerability-remediation for a first software application; classifying vulnerability remediation associated with the first software application as a respective initial classification from a predetermined set of classifications using at least the metric; predicting a first sequence comprising one or more predicted classifications, from the predetermined set of classifications, that the first software application is predicted to be classified as at a set of discrete future times; and generating a data object that identifies the first software application and indicates at least one of the respective initial classification or the first sequence.

Example 11. The system of Example 10, wherein the processor-executable instructions further cause the one or more processors to perform operations comprising: computing an updated metric indicative of time-to-vulnerability-remediation for the first software application; re-classifying vulnerability remediation associated with the first software application as an updated respective classification from the predetermined set of classifications using at least the updated metric; predicting an updated first sequence comprising one or more predicted classifications, from the predetermined set of classifications, that the first software application is predicted to be classified as at a set of discrete future times; and generating an updated data object that identifies the first software application and is indicative of at least one of the updated respective classification or the updated first sequence.

Example 12. The system of Example 10, wherein the processor-executable instructions cause the one or more processors to predict the first sequence at least in part by: determining frequencies at which software applications transition from one classification before re-classification to a second classification after re-classification; generating a transition (probability) matrix based on the determined frequencies; determining a Markov chain based on the transition (probability) matrix; and generating the first sequence based on the Markov chain.

Example 13. The system of Example 12, wherein the processor-executable instructions cause the one or more processors to, when the Markov chain has a steady state, generate the updated data object to be indicative of the steady state.

Example 14. The system of Example 10, wherein the metric indicative of time-to-vulnerability-remediation comprises a median time-to-vulnerability-remediation.

Example 15. The system of Example 14, wherein the processor-executable instructions cause the one or more processors to compute the median time-to-vulnerability-remediation using a survival analysis technique, the survival analysis technique comprising at least one of a Kaplan-Meier estimator or a proportional hazards model.

Example 16. The system of Example 15, wherein the survival analysis technique is the Kaplan-Meier estimator and the predetermined set of classifications comprises at least one of: a first classification that is indicative of applications where a Kaplan-Meier median can be computed for a set of durations of vulnerabilities associated with the application and detected or received within an enrollment window; a second classification that is indicative of applications where a Kaplan-Meier median cannot be computed for the set of durations and vulnerabilities were detected or received within the enrollment window; a third classification that is indicative of applications where the Kaplan-Meier median cannot be computed for the set of durations and no vulnerabilities were detected or received within the enrollment window and vulnerabilities were detected or received after the enrollment window closed; a fourth classification that is indicative of applications where a Kaplan-Meier median cannot be computed for the set of durations, no vulnerabilities were detected or received within the enrollment window, no vulnerabilities were detected or received after the enrollment window closed, and vulnerabilities were detected or received prior to the enrollment window opening; or a fifth classification that is indicative of applications where a Kaplan-Meier median cannot be computed for the set of durations, no vulnerabilities were detected or received prior to the enrollment window opening, no vulnerabilities were detected or received within the enrollment window, and no vulnerabilities were detected or received after the enrollment window closed.

Example 17. One or more non-transitory computer-readable storage media storing processor-executable instructions that, when executed by one or more processors, cause the one or more processors to perform operations comprising: computing a metric indicative of time-to-vulnerability-remediation for a first software application; classifying vulnerability remediation associated with the first software application as a respective initial classification from a predetermined set of classifications using at least the metric; predicting a first sequence comprising one or more predicted classifications, from the predetermined set of classifications, that the first software application is predicted to be classified as at a set of discrete future times; and generating a data object that identifies the first software application and indicates at least one of the respective initial classification or the first sequence.

Example 18. The one or more non-transitory computer-readable storage media of Example 17, wherein the processor-executable instructions further cause the one or more processors to perform operations comprising: computing an updated metric indicative of time-to-vulnerability-remediation for a first software application; re-classifying vulnerability remediation associated with the first software application as an updated respective classification from the predetermined set of classifications using at least the updated metric; predicting an updated first sequence comprising one or more predicted classifications, from the predetermined set of classifications, that the first software application is predicted to be classified as at a set of discrete future times; and generating an updated data object that identifies the first software application and indicates at least one of the updated respective classification or the updated first sequence.

Example 19. The one or more non-transitory computer-readable storage media of claim 17, wherein the processor-executable instructions cause the one or more processors to predict the first sequence at least in part by: determining frequencies at which software applications transition from one classification before re-classification to a second classification after re-classification; generating a transition (probability) matrix based on the determined frequencies; determining a Markov chain based on the transition (probability) matrix; and generating the updated first sequence based on the Markov chain.

Example 20. The one or more non-transitory computer-readable storage media of Example 17, wherein the processor-executable instructions cause the one or more processors to compute the metric indicative of time-to-vulnerability-remediation at least in part by using at least one of a Kaplan-Meier estimator or a proportional hazards model.

Example 21. The method of any one of Examples 1-9, wherein the data object further indicates the metric.

Example 22. The method of Example 2, wherein the updated data object further indicates the updated metric.

Example 23. The method of any one of Examples 1-9, further comprising computing, by one or more processors, a metric indicative of adherence of the first software application to at least one service level agreement.

Example 24. The method of Example 23, wherein the data object further indicates the metric indicative of adherence of the software application to at least one service level agreement.

Example 25. The method of any one of Example 1-9, further comprising computing, by one or more processors, a metric indicative of an age of an oldest vulnerability associated with the first software application.

Example 26. The method of Example 25, wherein the data object further indicates the metric indicative of an age of an oldest vulnerability associated with the first software application.

### Additional Considerations

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components include a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These include physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is included in at least one embodiment, but not every embodiment necessarily includes the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not include other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” can be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may include a single machine-learned model or multiple machine-learned models, such as a pipeline comprising two or more machine-learned models arranged in series and/or parallel, an agentic framework of machine-learned models, or the like.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

1. A method comprising:
computing, by one or more processors, a metric indicative of time-to-vulnerability-remediation for a first software application;
classifying, by the one or more processors, vulnerability remediation associated with the first software application as a respective initial classification from a predetermined set of classifications using at least the metric;
predicting, by the one or more processors, a first sequence comprising one or more predicted classifications, from the predetermined set of classifications, that the first software application is predicted to be classified as at a set of discrete future times; and
generating, by the one or more processors, a data object that identifies the first software application and indicates at least one of the respective initial classification or the first sequence.

2. The method of claim 1, further comprising:
computing, by the one or more processors, an updated metric indicative of time-to-vulnerability-remediation for the first software application;
re-classifying, by the one or more processors, vulnerability remediation associated with the first software application as an updated respective classification from the predetermined set of classifications using at least the updated metric;
predicting, by the one or more processors, an updated first sequence comprising one or more predicted classifications, from the predetermined set of classifications, that the first software application is predicted to be classified as at a set of discrete future times; and
generating, by the one or more processors, an updated data object that identifies the first software application and indicates at least one of the updated respective classification or the updated first sequence.

3. The method of claim 1 wherein the first software application is an element of a set of software applications.

4. The method of claim 1, wherein predicting the first sequence comprises:
determining frequencies at which one or more software applications have transitioned from one classification before re-classification to a second classification after re-classification during a time window;
generating a transition (probability) matrix based on the determined frequencies;
determining a Markov chain based on the transition (probability) matrix; and
generating the first sequence based on the Markov chain.

5. The method of claim 1, wherein the first sequence further comprises one or more matrices that are computed using a Markov chain and are indicative of one or more probabilities that the first software application will be classified as one or more classifications from the predetermined set of classifications at a discrete set of times.

6. The method of claim 5, further comprising:
determining to schedule the first software application for uninstallation or decommissioning based at least in part on at least one of:
determining the Markov chain has a steady state,
determining a frequency with which one or more classifications from the predetermined set of classifications appear in the first sequence, or
determining that a first probability of a set of probabilities associated with the steady state meets or exceeds a threshold.

7. The method of claim 1, wherein computing the metric comprises determining a median time-to-vulnerability-remediation.

8. The method of claim 7, wherein computing the median time-to-vulnerability-remediation comprises using a survival analysis technique, the survival analysis technique comprising at least one of a Kaplan-Meier estimator or a proportional hazards model.

9. The method of claim 8, wherein the survival analysis technique is the Kaplan-Meier estimator and the predetermined set of classifications comprises at least one of:
a first classification that is indicative of applications where a Kaplan-Meier median can be computed for a set of durations of vulnerabilities associated with the application and detected or received within an enrollment window;
a second classification that is indicative of applications where a Kaplan-Meier median cannot be computed for the set of durations and vulnerabilities were detected or received within the enrollment window;
a third classification that is indicative of applications where a Kaplan-Meier median cannot be computed for the set of durations, no vulnerabilities were detected or received within the enrollment window, and vulnerabilities were detected or received after the enrollment window closed;
a fourth classification that is indicative of applications where a Kaplan-Meier median cannot be computed for the set of durations, no new vulnerabilities were detected or received within the enrollment window, no vulnerabilities were detected or received after the enrollment window closed, and vulnerabilities were detected or received prior to the enrollment window opening; or
a fifth classification that is indicative of applications where a Kaplan-Meier median cannot be computed for the set of durations, no vulnerabilities were detected or received prior to the enrollment window opening, no vulnerabilities were detected or received within the enrollment window, and no vulnerabilities were detected or received after the enrollment window closed.

10. A system comprising:
one or more processors; and
one or more memories storing processor-executable instructions that, when executed by the one or more processors, cause the one or more processors to perform operations comprising:
computing a metric indicative of time-to-vulnerability-remediation for a first software application;
classifying vulnerability remediation associated with the first software application as a respective initial classification from a predetermined set of classifications using at least the metric;
predicting a first sequence comprising one or more predicted classifications, from the predetermined set of classifications, that the first software application is predicted to be classified as at a set of discrete future times; and
generating a data object that identifies the first software application and indicates at least one of the respective initial classification or the first sequence.

11. The system of claim 10, wherein the processor-executable instructions further cause the one or more processors to perform operations comprising:
computing an updated metric indicative of time-to-vulnerability-remediation for the first software application;
re-classifying vulnerability remediation associated with the first software application as an updated respective classification from the predetermined set of classifications using at least the updated metric;
predicting an updated first sequence comprising one or more predicted classifications, from the predetermined set of classifications, that the first software application is predicted to be classified as at a set of discrete future times; and
generating an updated data object that identifies the first software application and is indicative of at least one of the updated respective classification or the updated first sequence.

12. The system of claim 10, wherein the processor-executable instructions cause the one or more processors to predict the first sequence at least in part by:
determining frequencies at which software applications transition from one classification before re-classification to a second classification after re-classification;
generating a transition (probability) matrix based on the determined frequencies;
determining a Markov chain based on the transition (probability) matrix; and
generating the first sequence based on the Markov chain.

13. The system of claim 12, wherein the processor-executable instructions cause the one or more processors to, when the Markov chain has a steady state, generate the updated data object to be indicative of the steady state.

14. The system of claim 10, wherein the metric indicative of time-to-vulnerability-remediation comprises a median time-to-vulnerability-remediation.

15. The system of claim 14, wherein the processor-executable instructions cause the one or more processors to compute the median time-to-vulnerability-remediation using a survival analysis technique, the survival analysis technique comprising at least one of a Kaplan-Meier estimator or a proportional hazards model.

16. The system of claim 15, wherein the survival analysis technique is the Kaplan-Meier estimator and the predetermined set of classifications comprises at least one of:
a first classification that is indicative of applications where a Kaplan-Meier median can be computed for a set of durations of vulnerabilities associated with the application and detected or received within an enrollment window;
a second classification that is indicative of applications where a Kaplan-Meier median cannot be computed for the set of durations and vulnerabilities were detected or received within the enrollment window;
a third classification that is indicative of applications where the Kaplan-Meier median cannot be computed for the set of durations and no vulnerabilities were detected or received within the enrollment window and vulnerabilities were detected or received after the enrollment window closed;
a fourth classification that is indicative of applications where a Kaplan-Meier median cannot be computed for the set of durations, no vulnerabilities were detected or received within the enrollment window, no vulnerabilities were detected or received after the enrollment window closed, and vulnerabilities were detected or received prior to the enrollment window opening; or
a fifth classification that is indicative of applications where a Kaplan-Meier median cannot be computed for the set of durations, no vulnerabilities were detected or received prior to the enrollment window opening, no vulnerabilities were detected or received within the enrollment window, and no vulnerabilities were detected or received after the enrollment window closed.

17. One or more non-transitory computer-readable storage media storing processor-executable instructions that, when executed by one or more processors, cause the one or more processors to perform operations comprising:
computing a metric indicative of time-to-vulnerability-remediation for a first software application;
classifying vulnerability remediation associated with the first software application as a respective initial classification from a predetermined set of classifications using at least the metric;
predicting a first sequence comprising one or more predicted classifications, from the predetermined set of classifications, that the first software application is predicted to be classified as at a set of discrete future times; and
generating a data object that identifies the first software application and indicates at least one of the respective initial classification or the first sequence.

18. The one or more non-transitory computer-readable storage media of claim 17, wherein the processor-executable instructions further cause the one or more processors to perform operations comprising:
computing an updated metric indicative of time-to-vulnerability-remediation for a first software application;
re-classifying vulnerability remediation associated with the first software application as an updated respective classification from the predetermined set of classifications using at least the updated metric;
predicting an updated first sequence comprising one or more predicted classifications, from the predetermined set of classifications, that the first software application is predicted to be classified as at a set of discrete future times; and
generating an updated data object that identifies the first software application and indicates at least one of the updated respective classification or the updated first sequence.

19. The one or more non-transitory computer-readable storage media of claim 17, wherein the processor-executable instructions cause the one or more processors to predict the first sequence at least in part by:
determining frequencies at which software applications transition from one classification before re-classification to a second classification after re-classification;
generating a transition (probability) matrix based on the determined frequencies;
determining a Markov chain based on the transition (probability) matrix; and
generating the updated first sequence based on the Markov chain.

20. The one or more non-transitory computer-readable storage media of claim 17, wherein the processor-executable instructions cause the one or more processors to compute the metric indicative of time-to-vulnerability-remediation at least in part by using at least one of a Kaplan-Meier estimator or a proportional hazards model.
